(19) United States
(12) Patent Application Publication
(10) Pub. No.: US 2005/0013262 A1
(43) Pub. Date: Jan. 20, 2005

(54) Data packet header processing device for two-level switching via a logical bus within a satellite communication network

(75) Inventors: Tarif Zein Al-Abedeen, Castanet (FR); Laurence Duquerroy, Toulouse (FR); Stephane Combes, Toulouse (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/834,023

(22) Filed: Apr. 29, 2004

(30) Foreign Application Priority Data
Apr. 30, 2003 (FR) 03 05 301

(51) Int. Cl. H04B 7/185; H04L 12/56

(52) U.S. Cl. 370/316; 370/392

(57) ABSTRACT

A device (D) is dedicated to processsing data frames for satellite terminals (ST) of a satellite communication network, connected to at least one logical bus (B) defined on a satellite connection. The device (D) comprises processing means (MT) adapted, on receiving packets of a data frame from a first communication equipment (UE11), connected to a first satellite terminal (ST1) coupled to said device (D), and addressed to a second communication equipment (UE2), connected to a second satellite terminal (ST2), to encapsulate each packet received in a level 2 transmisstion protocol header (of the ISO layered model) comprising at least the identifier of the bus to which the second satellite terminal (ST2) is connected and the communication identifier of the first satellite terminal (ST1), before it is transmitted to the satellite (SAT), via the connection.

The invention relates to the field of communication between communication equipments of a satellite communication network, and more particularly to the transfer of data packet frames between communication equipments connected to satellite terminals.

In the present context, the expression “communication equipment” means any network equipment, and in particular any user equipment, such as fixed or portable computers or mobile telephones, routers, servers and gateways.

The person skilled in the art knows that data is generally transferred between communication equipments of a satellite communication network in a connected mode, for example the asynchronous transfer mode (ATM). Transfer is effected by way of satellite terminals to which the communication equipments are connected.

Because of this transfer mode, remote communication equipments are not able to exchange data (or traffic) until a physical or logical connection, for example an ATM virtual channel connection has been established between them. This kind of connection may be used for any type of service, for example interconnection of local area networks (LAN) or virtual private networks (VPN), or Internet access.

Setting up such connections necessitates the use of connection management systems that are generally complex and costly to develop and introduce sending delays and a traffic overhead induced by the exchange of signaling messages during the connection set-up and clearing down phases. Moreover, the connected transfer mode exposes the management system to scalability problems, since the maximum number of connections that may be established depends on the resources available.

Furthermore, the connected transfer mode is inappropriate to the non-connected nature of the Internet Protocol (IP).

To improve on this situation, there has recently been proposed a mechanism for a satellite communication network (or installation) using the dedicated IP non-connected (or datagram) transfer mode. In this network, data is exchanged on logical buses defined on the satellite links. This enables communication equipments to exchange data packets without having to set up a connection first. However, this mode of operation requires the satellite terminal to operate at the IP level, i.e. at level 3 of the ISO model. As a result of this, the satellite terminals must have access to routing tables and routing protocols that must be updated regularly. Also, problems may occur with transfer of packets at the level of the interconnections between IPv4 and IPv6 type networks. Moreover, this operating mode prevents the use of transmission protocols other than the IP protocol.

Consequently, prior art satellite communication networks are not entirely satisfactory.

One object of the invention is therefore to improve on this situation.

To this end it proposes a device dedicated to processing data packet frames for satellite terminals of a satellite communication network, having a communication identifier and being connected to at least one logical bus defined on a satellite link.

In the present context, the expression “satellite terminal” means a satellite terminal equipped with a processing device according to the invention. Of course, the installation may also comprise satellite terminals with no processing device according to the invention, but the invention does not relate to these.

The processing device is characterized in that it comprises processing means adapted, on receiving packets of a data frame (optionally segmented) from a first communication equipment, connected to a first satellite terminal coupled to said device, and addressed to a second communication equipment, connected to a second satellite terminal, to encapsulate each packet received in a level 2 sending protocol header comprising at least the identifier of the logical bus to which said second satellite terminal is connected and the communication identifier of the first satellite terminal, before it is sent to said satellite, via said connection. Thus the second satellite terminal is able to extract the encapsulated packets from the logical bus, which is designated by the identifier that they contain, where applicable after level 2 switching by the satellite.

In other words, the inherent broadcast capability of the satellite connections is used to operate them in the manner of a logical bus, for example of the Ethernet type, in a local area network (LAN). The satellite terminals, each of which is coupled to (or each of which integrates) a processing device according to the invention, process the routing of the data frames (for example of the Ethernet type) on the basis of the physical addresses indicated in the header of the frames (for example the Ethernet addresses). Each then behaves as a logical bridge. These bridges are “logical” in the sense that, on the satellite connection side, the satellite terminals are connected to logical buses and not to physical buses.

The level 2 sending protocol is preferably the Ethernet protocol and its derivatives or the token ring protocol and its derivatives.

The processing device according to the invention may comprise other complementary features, separately and/or in combination, and in particular:
a memory in which is stored at least one bus identifier and the communication identifiers (for example Ethernet addresses) of the communication equipment connected to the satellite terminal coupled to the device, and where applicable those coupled to other satellite terminals. In this case the processing means are adapted to compare the bus identifier contained in the header of each encapsulated packet circulating in the logical bus to said bus identifier stored in the memory. Then, if said bus identifiers are identical, the processing means are responsible for performing a filtering operation on the communication identifier of the second equipment, which is contained in each encapsulated packet;
a memory in which is stored a table of correspondences between communication equipment communication identifiers and logical bus identifiers;
the device may be installed in or coupled to a satellite terminal connected to a communication equipment providing access to a virtual private network designated by an access port number; in this case the logical bus (or one of the logical buses) is dedicated to the (virtual) private network; also, the table stored in the memory establishes a correspondence between communication equipment communication identifiers, access port identifiers, and logical bus identifiers;
a table establishing a correspondence between communication equipment communication identifiers, where applicable access port identifiers, and logical bus identifiers; in this case, firstly, if the satellite is of the multibeam type to cover a multiplicity of regions, and secondly, if the private network is subdivided in at least two portions installed in regions covered by different beams of the satellite, and if the satellite connection defines an intra-beam logical bus dedicated to each network portion and an inter-beam logical bus dedicated to said private network, the processing means are adapted to integrate into the header of the packets to be sent the identifier of the intra-beam logical bus or of the inter-beam logical bus (to which the second satellite terminal that is the destination of the encapsulated packets is connected) and the communication identifier of the first satellite terminal, so that the satellite can perform its level 2 switching function on the basis of the intra-beam or inter-beam bus identifier contained in the header of the encapsulated packets and the beam on which the encapsulated packets reach it; moreover, the processing means are then preferably adapted to compare the intra-beam or inter-beam bus identifier contained in the header of each encapsulated packet circulating in one or the other of said logical buses to the bus identifiers stored in the memory; accordingly, if the bus identifiers are identical, the processing means may perform a filtering operation on the communication address of the second equipment;
a table establishing a correspondence between communication equipment communication identifiers, where applicable access port identifiers, logical bus identifiers, and beam identifiers; in this case, firstly, if the satellite is of the multibeam type, to cover a multiplicity of regions, and of the packet switching type, secondly, if the private network is subdivided into at least two portions installed in regions covered by different beams of the satellite, designated by beam identifiers, and thirdly, if the satellite connection defines an inter-beam logical bus dedicated to the private network, then the processing means are preferably adapted to integrate into the header of the packets to be sent the identifier of the inter-beam logical bus (to which the second satellite terminal which is the destination of said packets is connected), the communication identifier of the first satellite terminal, and the identifier of the beam covering the region in which the second satellite terminal is installed; thus the satellite can perform its level 2 packet switching function on the basis of the identifier of the beam contained in the header of the encapsulated packets; in a variant in which the private network is divided into at least two portions installed in a region covered by one of the beams of the satellite, designated by beam identifiers, and the satellite connection defines an intra-beam logical bus dedicated to the private network, then the processing means are preferably adapted to integrate into the header of the packets to be sent the identifier of the intra-beam logical bus (to which is connected the second satellite terminal that is the destination of the packets), the communication identifier of the first satellite terminal, and the identifier of the beam that covers the region in which the second satellite terminal is installed;
a table establishing a correspondence between communication equipment communication identifiers, where applicable access port identifiers, logical bus identifiers, and beam identifiers; in this case, firstly, if the satellite is of the multibeam type, to cover a multiplicity of regions, and of the circuit-switched type, secondly, if the private network is subdivided into at least two portions installed in regions covered by different beams of the satellite, designated by beam identifiers, and thirdly, if the satellite link defines an inter-beam logical bus dedicated to the private network, then the processing means are preferably adapted i) to integrate into the header of the packets to be sent the identifier of the inter-beam logical bus (to which the second satellite terminal which is the destination of the frames is connected) and the communication identifier of the first satellite terminal, and ii) to instruct the sending of the encapsulated packets in a time slot dedicated to the beam covering the region in which the second satellite terminal is installed. In this way, the satellite may provide the level 2 circuit switching function starting from the time slot of sending of the encapsulated packets; in a variant in which the private network is subdivided into at least two portions installed in a region covered by one of the beams from the satellite, and the satellite link defines an intra-beam logical bus dedicated to the private network, then the processing means are preferably adapted i) to integrate into the header of the packets to be sent the identifier of the intra-beam logical bus (to which the second satellite terminal which is the destination of the frames is connected) and the communication identifier of the first satellite terminal, and ii) to instruct the sending of the encapsulated packets in a time slot dedicated to the beam covering the region in which the second satellite terminal is installed;
processing means adapted to compare the inter-beam (or intra-beam) bus identifier contained in the header of each encapsulated packet circulating in said inter-beam (or intra-beam) logical bus to the bus identifiers stored in the memory, and then, if the bus identifiers are identical, to perform a filtering operation on the communication address of the second equipment;
processing means adapted to determine by a learning process communication addresses of first and second equipments and/or corresponding port numbers and/or corresponding logical bus identifiers and/or corresponding beam identifiers, to feed said correspondence table;
processing means adapted to generate request-frames to a remote satellite terminal to determine information representative of a second equipment communication address and/or a corresponding port number and/or a corresponding logical bus identifier and/or a corresponding beam identifier, so as to be able to construct the header of the packets to be sent to said second equipment, and then to feed said correspondence table with said information obtained; similarly the processing means are adapted, on receiving request-frames, to transmit response-frames comprising the required information; each request-frame and each response-frame is of the Internet standard Address Resolution Protocol (ARP) type, for example.

The invention also relates to a satellite terminal equipped with a processing device of the type described hereinabove and a satellite communication installation equipped with satellite terminals of the type described hereinabove.

That installation may comprise one or more private networks each connected to a dedicated logical bus. Instead of this, or in addition to this, the installation may comprise a public data network, for example of the Internet/IP type, connected to a dedicated public logical bus. In the presence of local area network(s) and a data network, the public logical bus is also connected to at least one of the primary satellite terminals coupled to one of the local area networks.

Moreover, the installation may comprise a multibeam satellite to cover a multiplicity of regions. This satellite may provide circuit switching or packet switching.

Other features and advantages of the invention will become apparent on examining the following detailed description and the appended drawings, in which:

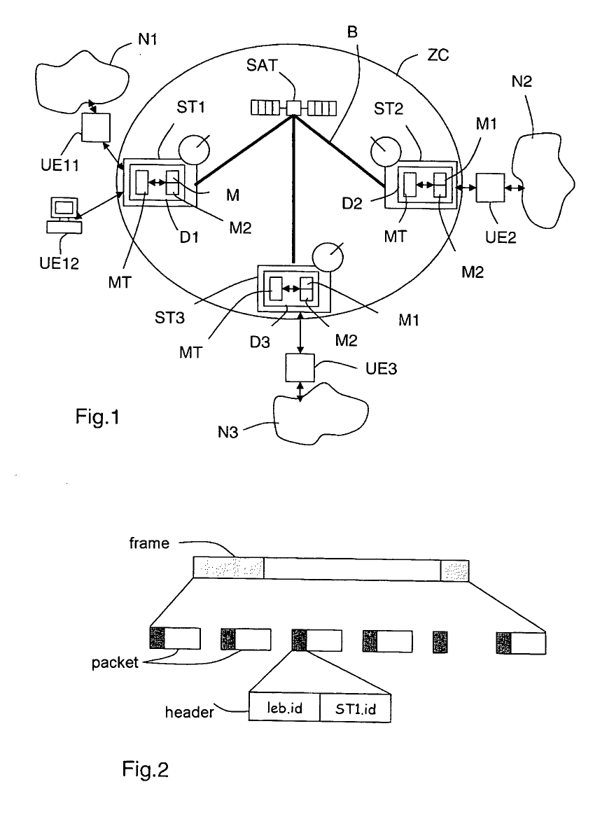

FIG. 1 shows diagrammatically a first embodiment of a satellite communication installation equipped with processing devices according to the invention,

FIG. 2 shows diagrammatically an encapsulated data packet frame suited to the FIG. 1 installation,

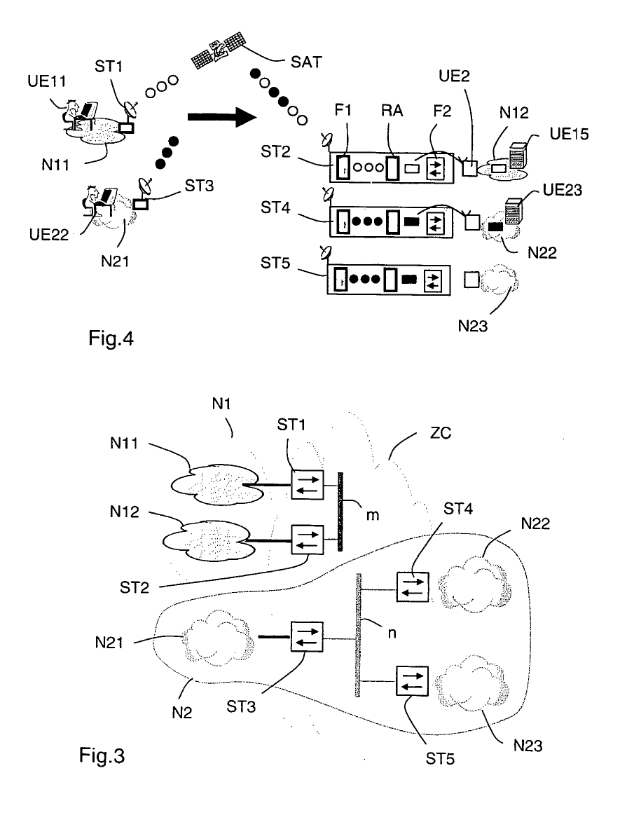

FIG. 3 shows diagrammatically a second embodiment of a satellite communication installation according to the invention,

FIG. 4 shows diagrammatically the data packet sending mechanism of the invention in the case of the FIG. 3 installation,

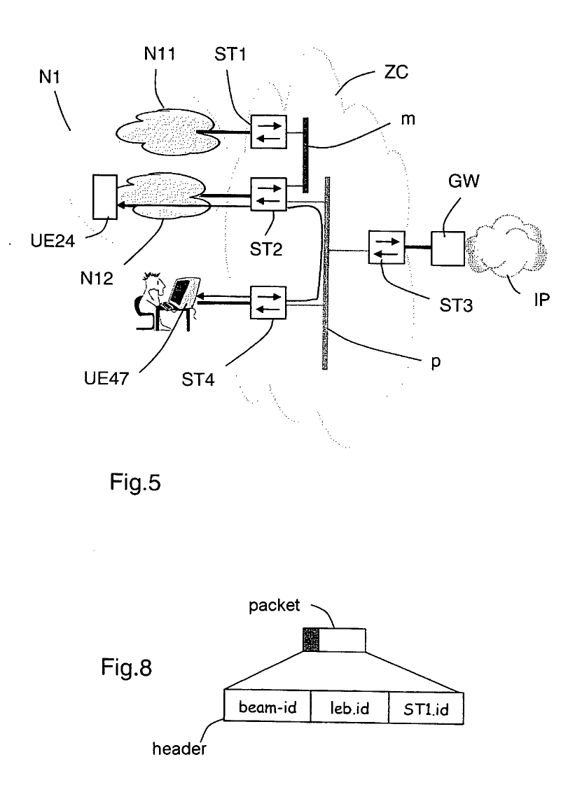

FIG. 5 shows diagrammatically a third embodiment of a satellite communication installation of the invention,

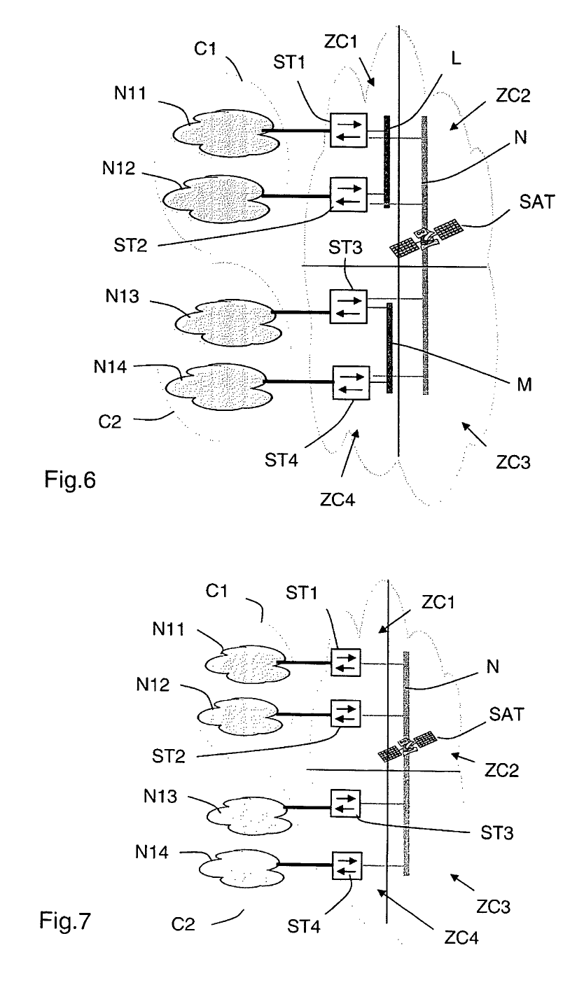

FIG. 6 shows diagrammatically a fourth embodiment of a satellite communication installation of the invention,

FIG. 7 shows diagrammatically a fifth embodiment of a satellite communication installation of the invention,

FIG. 8 shows diagrammatically a modified ARP frame suitable for the FIG. 7 installation, and

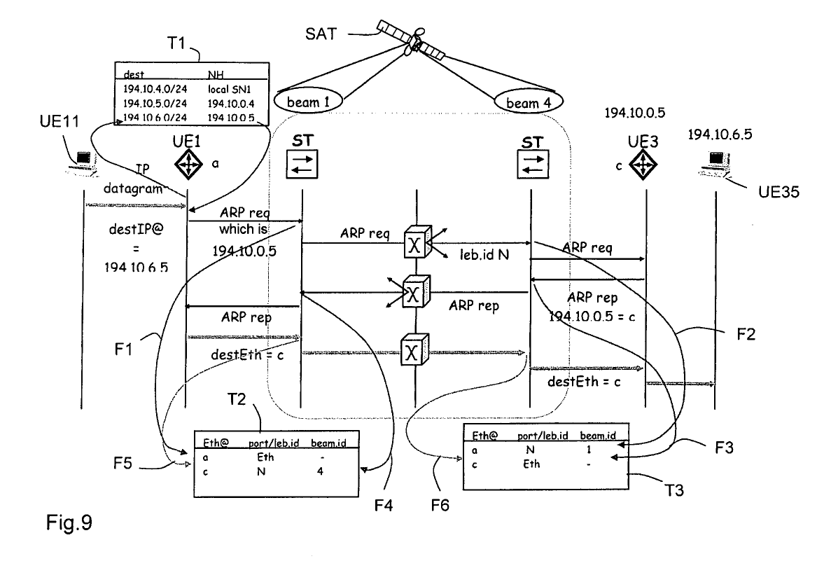

FIG. 9 shows diagrammatically the main steps of encapsulated data packet sending integrating a phase of searching for address information using ARP type requests.

The appended drawings may constitute part of the description of the invention as well as, if necessary, contributing to the definition of the invention.

The invention relates to the transfer, within a satellite communication installation, of data packet frames between communication equipments connected to remote satellite terminals.

A first embodiment of a satellite communication installation according to the invention is described first with reference to FIGS. 1 and 2.

In the example shown, the installation comprises a communication satellite SAT providing a coverage region ZC and a multiplicity of satellite terminals STi (in this example i=1 to 3, but i can take any value greater than or equal to two (2)), interconnected by satellite connections via said satellite SAT.

Each satellite terminal STi is coupled to at least one communication equipment UEij.

In the present context, the expression “communication equipment”(“equipment” hereinafter) means any network equipment, and in particular user equipments such as fixed or portable computers, fixed or mobile telephones, facsimile machines, personal digital assistants (PDA), servers, for example those belonging to application service providers (ASP), routers and gateways.

In the example shown, a first satellite terminal ST1 is connected, firstly, to a first router UE11, which is in turn connected to a first local network N1, and, secondly, to user equipments UE12, for example fixed or portable computers.

For example, the first local network N1 is a local area network (LAN) adapted to exchange encapsulated data frames using the Ethernet level 2 (data link layer) sending protocol of the ISO model. However, the invention is not limited to this level 2 sending protocol of the ISO model, of course. Generally, the invention applies to all types of level 2 protocol, and in particular to the 802.4, 802.5 and 802.11 protocols.

Moreover, the user equipments UE12 are adapted to exchange encapsulated data frames with the satellite terminal ST1 using the Ethernet sending protocol.

In the example shown, a second satellite terminal ST2 is connected to a second router UE2 which is in turn connected to a second local network N2. The second local network N2 is adapted to exchange encapsulated data frames using the Ethernet sending protocol, for example. Moreover, a third satellite terminal ST3 is connected to a second router UE3 which is in turn connected to a third local network N3 adapted to exchange encapsulated data frames using the Ethernet sending protocol, for example.

Each satellite terminal STi is responsible, firstly, for sending over the air interface of the satellite network Ethernet format data frames that it receives from a user equipment UEi, possibly after segmenting them into packets of fixed or variable size to adapt them to the sending format of the satellite link (or connection), and, secondly, for sending to the user equipment UEi concerned of data frames that it receives over the air interface of the satellite network, where applicable after reassembly of the packets.

As will emerge later, the satellite terminal STi of the invention provides a bridging function because, processing only the level 2 Ethernet sending protocol, it essentially provides switching of the traffic as a function of Ethernet physical addresses contained in frames received from a satellite SAT or a user equipment UEi. An Ethernet bridging function of this kind is defined by the IEEE standard 802.1d. It is used to determine how to forward frames to their respective destinations. To this end, each satellite terminal STi has a routing table that is usually filled in by means of a learning process, as defined in the IEEE standard 802.1d.

According to the invention, the satellite connection set up between the satellite terminals STi and the satellite SAT defines one or more logical buses B for broadcasting encapsulated Ethernet format frames.

The buses of the satellite interface are preferably not physical buses, like an Ethernet physical bus, for example, but logical buses. Consequently, each is identified by a logical identifier. Because the frames are to the Ethernet format, these buses are referred to as logical Ethernet buses.

Moreover, each satellite terminal STi of the invention may be treated as an Ethernet logical bridge providing level 2 switching.

Frames are therefore sent within the installation of the invention in non-connected mode, independently of any other higher level protocols that may be used. Level 3 (IP) protocols being transparent between satellite terminals STi, inter-terminal sending may therefore support any level 3 protocol, for example IPv4, IPv6, PPP, PPPOE, etc.

It is considered here that each satellite terminal STi of the installation is equipped with a processing device Di providing the bridging function of the invention. In the present context, the term “equipped with a processing device” means integrating a device Di or being connected directly thereto, for example in a plug and play mode.

However, the invention is not limited to installations that comprise only satellite terminals equipped with a processing device Di. The invention applies equally to installations comprising satellite terminals equipped with a processing device Di and satellite terminals with no such processing device Di. Thus in the remainder of the description the expression “satellite terminal” refers to a satellite terminal equipped with a device Di.

Each processing device Di according to the invention comprises a processing module MT which, when it receives packets of a data frame, possibly segmented packets, coming from a first equipment (source equipment) and addressed to a remote second equipment (destination equipment), is responsible for encapsulating each packet received in a level 2 sending protocol header comprising, as shown in FIG. 2, at least the identifier (leb.id) of the logical bus B to which is connected the satellite terminal STj coupled to the destination equipment UEj and the communication identifier (for example the physical communication address) ST1.id of the (source) satellite terminal ST1 including it.

In other words, there is added to the start of the header an identification field for the logical bus B on which the encapsulated Ethernet frames must be broadcast.

Because the identifier of the logical bus is not supplied by the source equipment UE, it is the processing module MT of the device D that must determine it from the physical communication address (Ethernet address) of the destination equipment UE′, which is contained in the packets coming from the source equipment UE. To this end, a second memory M2 is provided for storing a table establishing the correspondences between communication equipment communication addresses (or identifiers) and logical bus identifiers. This second memory M2 is preferably in the processing device D, in which it is connected to the processing module MT. Accordingly, when the processing module MT receives packets from a source equipment, it reads the communication address of the destination equipment and then accesses the second memory M2 to determine in its correspondence table the associated bus identifier leb.id.

When a satellite terminal ST is connected to communication equipments UE providing access to a virtual private network (VPN) grouping a plurality of local area networks (LAN), for example conforming to the Ethernet protocol, the correspondence table preferably further comprises the correspondences between the physical communication addresses of the equipments and their port identifier.

Various ways to fill in the correspondence table are described later, with reference to FIG. 9.

Once encapsulation has been effected, the processing module MT is responsible for instructing the sender module of its satellite terminal STi to send the encapsulated packets to the satellite via the satellite connection.

The encapsulated packets are thus integrated into frames broadcast on the logical bus B, so that all the satellite terminals STi that are connected to the logical bus B are able to “listen” to the traffic on it and to determine, by filtering, if the encapsulated packets are addressed to one of the equipments UEi to which they are connected.

This filtering is effected by the processing module MT of the device Di. To be more precise, the filtering is two-fold. A first filtering operation F1 is applied first to the content of the identification field leb.id of the bus. Here, the processing module MT must compare the content leb.id of this field to a value stored in a first memory M1 and designating the logical bus(es) to which the device Di is coupled. If the content of this field is different from one of the stored values (this situation is described later, and corresponds to multiplexing of logical buses onto the same satellite connection), then the encapsulated packet is not retained. On the other hand, if they are identical, the processing module MT must apply a second filtering operation F2 relating to the communication address of the destination equipment, which is contained in the filtered packets in accordance with the bridging methods defined in the IEEE standard 802.1d.

FIG. 4 shows this two-fold filtering diagrammatically, in the case of multiplexing onto the same satellite connection two Ethernet logical buses, with respective identifiers leb.id=n and leb.id=m. To be more precise, in this example, which corresponds to a second embodiment of an installation according to the invention (shown in FIG. 3), a first company has a first virtual private network N1 of which a first satellite terminal ST1 is connected to a first sub-network N11 and a second satellite terminal ST2 is connected to a second sub-network N12 via a first logical bus whose identifier is leb.id=m. Moreover, a second company has a second virtual private network N2 connecting, via a second logical bus whose identifier is leb.id=n, a first local sub-network N21 via a first satellite terminal ST3, a second local sub-network N22 via a second satellite terminal ST4, and a third local sub-network N23 via a third satellite terminal ST5. The three sub-networks N21, N22 and N23 correspond to three different sites of the second company, for example.

The user of the user equipment UE11 of the sub-network N11 here requires to transmit data to the user equipment UE15 of the sub-network N12. The user equipment UE11 then transmits a data packet frame to the satellite terminal ST1 containing the communication address of the destination user equipment UE15.

The processing module MT reads the communication address of the destination user equipment UE15, and then accesses the second memory M2 to determine in its correspondence table the associated bus identifier leb.id. It is assumed here that this address is known, or at least that the address of the communication equipment UE2 providing access to the sub-network N12 of the user equipment UE15 is known.

The processing module MT of the source satellite terminal ST1 then integrates into the header of the received packets the identifier ST1.id designating the source satellite terminal ST1 and the identifier of the logical bus leb.id=m to which the satellite terminal ST2 is connected, to which the destination user equipment UE15 (or UE2) is indirectly connected. It then instructs the sending module of the satellite terminal ST2 to transmit the Ethernet frame to the satellite SAT.

Thus the encapsulated packets reach the satellite SAT, which switches them onto the first logical bus m as a function of their field leb.id=m. The packets are broadcast on the first logical bus m and reach the satellite terminal ST2. The processing module MT of the device D2 then applies the first filtering operation F1. The encapsulated packets, whose header contains the identifier leb.id=m and the identifier ST1.id of the source satellite terminal ST1, are then reassembled (RA), after which they are subjected to a second filtering operation F2 in accordance with the standard bridging methods. In fact, here the processing module MT instructs switching of the encapsulated packets to the router UE2 managing access to the sub-network N12, which thereafter switches said packets to the user equipment UE15.

At substantially the same time, in this example, the user of the user equipment UE21 of the sub-network N21 requires to send data to the user equipment UE23 of the sub-network N22. The user equipment UE21 then sends a data frame to the source satellite terminal ST3 that includes the communication address of the destination user equipment UE23.

The processing module MT reads the communication address of the destination user equipment and then accesses the second memory M2 to determine in its correspondence table the associated bus identifier leb.id. It is assumed here that this address is known, or at least that the address of the communication equipment UE4 providing access to the sub-network N22 to which the user equipment UE23 belongs is known.

The processing module MT of the source satellite terminal ST3 then integrates into the header of the packets, where applicable after segmentation of the received data frame, the identifier ST1.id designating the source satellite terminal ST3 and the identifier of the logical bus leb.id=n to which is connected the destination satellite terminal ST4 that is indirectly coupled to the destination user equipment UE23, via the user equipment UE4. It then instructs the sender module of the satellite terminal ST3 to send the packets constituting the Ethernet frame to the satellite SAT.

The encapsulated packets then reach the satellite SAT, which switches them onto the second logical bus n as a function of its field leb.id=n. The encapsulated packets are broadcast on the second logical bus n and reach the satellite terminal ST4. The processing module MT of the device D4 then applies the first filtering operation F1. The encapsulated packets whose header contains the identifier leb.id=n and the identifier ST1.id of the source satellite terminal ST3 are then reassembled RA to reconstitute the original frame, after which the reconstituted frame is subjected to a second filtering operation F2 in accordance with the standard bridging methods.

During this time, the encapsulated packets broadcast on the second logical bus n reach the satellite terminal ST5. The processing module MT of the device D5 then applies its first filtering operation F1. The encapsulated packets whose header contains the identifier leb.id=n and the identifier ST1.id are then reassembled RA, after which the reconstituted frame is subjected to a second filtering operation F2 in accordance with the standard bridging methods. Here, the processing module MT notices that the address of the destination user equipment UE23 contained in the frame does not correspond to any of the addresses of the user equipments to which the satellite terminal ST5 is connected. The frame is therefore eliminated.

It is important to note that the switching effected by the satellite SAT may be packet switching or circuit switching.

A third embodiment of an installation according to the invention is described next with reference to FIG. 5.

In this embodiment, the satellite again offers only single-beam coverage. Here the installation comprises a first private network N1, for example a virtual private network, which may be divided into two local sub-networks N11 and N12 each connected to a satellite terminal ST1, ST2. The two satellite terminals ST1 and ST2 are interconnected via a private logical first bus m whose identifier is leb.id=m, defined via the satellite SAT. Moreover, the installation further comprises, firstly, a third satellite terminal ST3 connected, for example via a gateway type communication equipment GW, to an Internet/IP public data network, and, secondly, to a fourth satellite terminal ST4 to which user equipments UE are connected. These two satellite terminals ST3 and ST4 are interconnected via a public logical second bus p whose identifier is leb.id=p, defined via the satellite SAT, and to which the satellite terminal ST2 of the sub-network N12 is also connected.

The memory M1 of the device D equipping the station ST2 therefore stores the bus identifier values m and p in order to be able to filter not only the encapsulated packets circulating on the private logical first bus m but also those circulating on the public logical second bus p.

For example, one of the users, whose user equipment UE47 is connected to the satellite terminal ST4, wishes to exchange data using the Internet protocol with a user equipment UE24 of the sub-network N12. It then sends to the source satellite terminal ST4 IP datagrams comprising the communication address of the destination communication equipment UE24, which it may have recovered beforehand in the IP network, via the public logical bus p. The processing module MT reads the communication address of the destination equipment and then accesses the second memory M2 to determine in its correspondence table the associated bus identifier leb.id. The processing module MT of the device D equipping the source satellite terminal ST4 then integrates into the header of the packets received the identifier ST1.id of said source satellite terminal ST4 and the identifier of the public logical bus leb.id=p to which the satellite terminal ST2 is connected that is connected indirectly to the destination user equipment UE24. It then instructs the sender module of the source satellite terminal ST4 to send the Ethernet frame to the satellite SAT.

The encapsulated packets then reach the satellite SAT, which switches them on the second public logical bus p as a function of its field leb.id=p. The encapsulated packets are then broadcast on the public logical bus p and reach the satellite terminal ST2. The processing module MT of the device D2 then applies its first filtering operation F1. The memory M1 of the device D2 of the terminal ST2 containing the values m and p, all the encapsulated packets whose header contains the identifier leb.id=p and the identifier ST1.id of the source satellite terminal ST4 are therefore reassembled RA, after which the reconstituted frame is subjected to a second filtering operation F2 in accordance with the standard bridging methods. The processing module MT verifies that the address of the destination equipment UE24 contained in the reconstituted frame corresponds to one of the addresses of the equipments to which the satellite terminal ST2 is coupled. That being so here, the processing module MT instructs the satellite terminal ST2 to switch the reconstituted frame at level 2 to the destination user equipment UE24. In fact, it instructs that the reconstituted frame be switched to the router UE2 managing access to the sub-network N12, which then switches said packets to the user equipment UE24.

A fourth embodiment of an installation according to the invention is described next with reference to FIG. 6. This embodiment corresponds to an installation in which the satellite SAT is of the multibeam type, and consequently covers a multiplicity of regions (or “spots”) with each of its beams.

To be more precise, in the example shown, a virtual private network (VPN) N1 is distributed across two regions ZC1 and ZC4 of the four coverage regions ZC1 to ZC4 of the satellite SAT. This situation corresponds, for example, to a business having subsidiaries at very different locations, for example on different continents. For example, a first local sub-network N11 and a second local sub-network N12 of the private network N1 are on a first continent C1 and each is connected via a communication equipment UE (not shown) to a satellite terminal ST1, ST2 installed in the first coverage region ZC1 of the satellite SAT. Similarly, a third local sub-network N13 and a fourth local sub-network N14 of the private network N1 are installed on a second continent C2 and each is connected via a communication equipment UE (not shown) to a satellite terminal ST3, ST4 installed in the fourth coverage region ZC4 of the satellite SAT.

The first and second satellite terminals ST1, ST2 are interconnected via a private intra-beam logical bus L, whose identifier is leb.id=L. The third and fourth satellite terminals ST3, ST4 are interconnected via a private intra-beam logical bus M, whose identifier is leb.id=M. Each intra-beam logical bus is dedicated to the exchange of data, in broadcast mode, between sub-networks installed in the same region. For example, there is also defined on the satellite connection an inter-beam private logical bus N, whose identifier is leb.id =N, connected to each of the satellite terminals ST1 to ST4. This private inter-beam logical bus N is dedicated to the exchange of data between sub-networks installed in different regions.

In this embodiment, it is again the processing module MT of the device D that reads the communication address of the destination equipment, and then accesses the second memory M2 to determine in its correspondence table the associated bus identifier leb.id. The processing module MT of the device D of the source satellite terminal ST that is coupled to the source user equipment UE therefore integrates into the header of the packets received the communication identifier ST1.id of the source satellite terminal ST and the identifier of the logical bus leb.id to which is connected the satellite terminal ST′ that is connected (indirectly) to the destination user equipment UE′.

Moreover, in this embodiment, it is just as if each satellite terminal ST1 to ST4 had two Ethernet ports, each corresponding to one of the two intra-beam and inter-beam logical buses to which it is connected. In order to be able to perform its switching functions, the satellite SAT comprises a memory in which is stored a correspondence table defining the destination region of an encapsulated frame, taking account of the source region and the bus identifier leb.id contained in the header of the packets of the frame. Thanks to this table, the processing module MT of a device D according to the invention does not need to specify explicitly in the header the beam for the destination equipment.

One example of this kind of table is reproduced below for illustrative purposes only:

| source region | leb. id | destination region |
|---|---|---|
| 1 | L | 1 |
| 4 | M | 4 |
| 1 | N | 4 |
| 4 | N | 1 |

For example, when the satellite SAT receives from the fourth region ZC4 (source region), on its fourth beam, packets whose header designates the intra-beam Ethernet bus M, it deduces from the correspondence table that the destination region is the fourth region ZC4. It therefore switches the encapsulated packets to the intra-beam Ethernet logical bus M. The encapsulated packets are then broadcast on the Ethernet intra-beam logical bus M and may be filtered by the third and fourth satellite terminals ST3, ST4, and then sent to the destination equipment designated in the header of the encapsulated packets.

On the other hand, if the satellite SAT receives from the fourth region ZC4 (source region), on its fourth beam, packets whose header designates the Ethernet inter-beam logical bus N, it deduces from the correspondence table that the destination region is the first region ZC1. It therefore switches the encapsulated packets to the Ethernet inter-beam logical bus N. The encapsulated packets are then broadcast on the Ethernet inter-beam logical bus N and may be filtered by the first and second satellite terminals ST1, ST2 and then sent to the destination equipment designated in the header of the encapsulated packets.

A fifth embodiment of an installation according to the invention is described next with reference to FIG. 7. This is in fact a variant of the FIG. 6 installation, in which the satellite SAT is also of the multibeam type.

To be more precise, in the example shown the virtual private network (VPN) N1 is again distributed over two regions (ZC1 and ZC4) of the four coverage regions ZC1 to ZC4 of the satellite SAT. A first local sub-network N11 and a second local sub-network N12 of the private network N1 are installed on a first continent and each is connected via a communication equipment UE (not shown) to a satellite terminal ST1, ST2 installed in the first coverage region ZC1 of the satellite SAT. Similarly, a third local sub-network N13 and a fourth local sub-network N14 of the private network N1 are installed on a second continent and each is connected via a communication equipment UE (not shown) to a satellite terminal ST3, ST4 installed in the fourth coverage region ZC4 of the satellite SAT.

Here the four satellite terminals ST1 to ST4 are connected to a single private inter-beam logical bus N, whose identifier is leb.id=N. The single bus N is dedicated to the exchange of data in broadcast mode between the sub-networks installed in the same region or in different regions.

For the satellite SAT to be able to effect level 2 switching, the satellite terminal SAT that is coupled to the source equipment UE must indicate to the satellite SAT the beam to which the destination equipment UE′ is attached. There are two preferred solutions to this, depending on the switching mode employed by the on-board processor (OBP) of the satellite SAT.

A first solution is suitable for packet-switching OBP. This solution consists in integrating into the header of the packets to be sent, by means of the processing module MT of the device D in the source satellite terminal ST coupled to the source equipment, the identifier (beam.id) of the beam for the destination equipment. This field being addressed to the satellite SAT, and to be more precise to its OBP, it is placed in the header of the packets, as shown in FIG. 8.

The beam identifier beam.id not being supplied by the source equipment UE, it is the processing module MT of the device D that must determine it from the physical communication address of the destination user equipment UE′ contained in the received packets. To this end, the correspondence table that the processing device D stores in its second memory M2 establishes the correspondences between the physical addresses of the communication equipments UE, the identifiers of the associated beams, and the associated logical bus identifiers. Accordingly, when the processing module M2 receives packets from a source equipment, it reads the communication address of the destination user equipment UE′and then accesses the second memory M2 to determine in its correspondence table the associated bus identifier leb.id and the associated beam identifier beam.id.

In this embodiment, the satellite SAT must therefore be adapted to effect its switching functions as a function of the identification field of the destination beam (beam.id).

A second solution is suitable for circuit-switching OBP. This solution corresponds to a mode of sending of encapsulated packets in time slots reserved for the beam covering the region in which the destination satellite ST′ to which the destination equipment UE′ is coupled is installed, and it is therefore not necessary to integrate a beam identification field into the header of the packets. The time slot to which the encapsulated packet belongs implicitly designates the beam that must be used to broadcast the encapsulated packets to the destination satellite terminal ST′ to which the destination equipment UE′ is coupled.

Accordingly, the satellite SAT may effect its level 2 circuit switching starting from the sending time slot of the encapsulated packets.

As previously mentioned, there are various ways to fill in the correspondence tables that are stored in the second memories M2 of the devices Di according to the invention.

A first way consists in periodically refreshing all the second memories M2 as a function of the communication equipments UE that are connected to all of the satellite terminals ST connected to the satellite terminal equipped with their processing device D.

A second way, that is preferred at present, consists in filling in each second memory M2 by means of a learning process using information contained in the received frames. FIG. 9 shows a learning process of this kind, in the context of a procedure for transmitting data between two remote equipments.

To be more precise, the example shown in FIG. 9 corresponds to an installation equipped with a multibeam satellite of the type shown in FIG. 7. For example, a user whose user equipment UE11 is connected to the local sub-network N11 requires to send IP datagrams to another user whose (destination) user equipment UE35 is connected to the local sub-network N13. In this example, the user equipment UE11 knows the Internet address of the destination user equipment UE35 (destIP@=194.10.6.5).

The datagrams are therefore sent to the router UE1 of the local sub-network N11, which is connected to the satellite terminal ST1, accompanied by the IP address of the user equipment UE35. The router UE1 has a routing table T1 defining the correspondences between destination IP addresses (dest) and IP addresses of the next hop (NH) routers that follow it. From the table T1 shown (top left), the next hop router (NH=UE3) that is associated with the destination IP address destIP@=194.10.6.5 is 194.10.0.5.

The router UE1 therefore sends the source satellite terminal ST1 an Ethernet format request-frame to request from the router UE3 (whose IP address is 194.10.0.5) its Ethernet physical address.

The request-frame is preferably of the address resolution protocol (ARP) type.

Remember that an ARP request is sent in broadcast mode, which means that the Ethernet physical address of the destination is replaced by data defining a broadcast address, for example of the “FFFFFFFFFFFF hex” type.

On receiving the ARP request frame, the source satellite terminal ST1 communicates it to the processing module MT of its device D1 so that it fulfils its bridging function. The processing module MT then stores in the correspondence table T2 of the memory M2 the Ethernet physical address (Eth@=a) of the router UE1 (arrow F1), if it does not know it already, in corresponding relationship to its Ethernet port number (Eth). It then integrates into the header of the request-frame (ARP req) the identifier (leb.id=N) of the bus to which the router UE3 is connected, the identifier ST1.id of the source satellite terminal ST1, and the beam number (beam.id=1) for ST1, and instructs the sending module of the source satellite terminal ST1 to send it to the satellite SAT. Given that the source satellite terminal ST1 does not yet know the beam in which the destination is located, it places in the beam.id field of the sent packets a particular value signifying that said packets must be broadcast. Thus, on receiving these packets, the satellite SAT broadcasts them on all its beams.

When the request-frame (ARP req) reaches the destination satellite terminal ST3, its processing module MT accesses its correspondence table T3 (arrow F2) to enter into it the information received (if it does not contain that information already). In this example, it supplies to the table T3 the communication address of the router UE1 (Eth@=a), its bus number (leb.id=N), and its beam number (beam.id=1). The destination satellite terminal ST3 then transmits the request-frame (ARP req) to the router UE3 to which it is connected and which designates it. The router UE3 then enters into its own correspondence table the information contained in the frame-request (ARP req), and generates a return ARP response-frame indicating that its IP address 194.10.0.5 corresponds to its Ethernet address c (Eth@=c).

This response-frame (ARP rep) is sent to the satellite terminal ST3, which communicates it to its processing module MT, which accesses its correspondence table T3 (arrow F3) to enter the received information in it (if it does not contain it already). In this example, it supplies to the table T3 the communication address of the router UE3 (Eth@=c) and its port number (Eth). It then integrates into the header of the response-frame (ARP rep) the beam number (beam.id =4) of the router UE3. It then integrates into the header of the packets the bus identifier (leb.id =N) for the destination terminal (here ST1), as well as its beam number (beam.id =1). It obtains this information from its table T3. It then instructs the satellite terminal ST3 to send the packets to the satellite SAT.

On receiving these packets, the satellite SAT broadcasts them on the beam N° 1.

When the response-frame (ARP rep) reaches the satellite terminal ST1 (after reassembly of the packets), its processing module MT accesses its correspondence table T2 (arrow F4) to enter into it the information received (if it does not contain it already). In this example it supplies to the table T2 the communication address of the router UE3 (Eth@=c), its bus number (leb.id =N), and its beam number (beam.id =4). The satellite terminal ST1 then sends the response-frame (ARP rep) to the router UE1 to which it is connected, after removing the information on the beam identifiers. The router UE1 then enters into its own correspondence table the information contained in the response-frame (ARP rep). Then, since it now knows the physical address of the equipment (here UE3) to which the data packets addressed to the destination user equipment UE35 must be sent, it sends said data packets accompanied by the Ethernet address (destEth=c) of the router UE3.

On receiving this data, the processing module MT of the source satellite terminal ST1 again accesses its correspondence table T2 (arrow F5) to determine the bus identifier (leb.id =N) and the beam identifier (beam.id=4) corresponding to the received Ethernet address (destEth =c). It then integrates into the header of the packets the identifier ST1.id, the bus identifier (leb.id=N), and the beam identifier (beam.id=4) extracted from the table T2, and then instructs the sending module of the satellite terminal ST1 to send the encapsulated packets to the satellite SAT. On receiving the encapsulated packets, the satellite SAT broadcasts them on the fourth beam, designated in their header, on the Ethernet logical bus N, also designated in their header.

When the encapsulated packets reach the destination satellite terminal ST3, the latter reconstitutes the Ethernet frame and its processing module MT accesses its correspondence table T3 (arrow F6) to determine the port number (Eth) corresponding to the Ethernet physical address (destEth=c). The destination satellite terminal ST3 then sends the reconstituted frame to the router UE3 to which it is connected and which is designated by the port number extracted from the correspondence table T3. The router UE3 may then forward the data frame to the destination user equipment UE35 whose IP address (destIP@=194.10.6.5) is contained in the header of the IP datagram sent by the frame.

The processing device D, principally its processing module MT and where applicable its memories M1 and M2, may take the form of electronic circuits, software modules, or a combination of circuits and software.

Thanks to the invention, the frames are sent in non-connected mode, independently of any other sending protocols that might be used, and in particular level 3 protocols (such as IPv4, IPv6 and PPP). There is therefore no longer any need to set up connections beforehand. Moreover, it is no longer necessary to duplicate the traffic to be broadcast and scalability problems no longer arise.

Moreover, configuring the installation (or network) is particularly simplified because, firstly, only a few parameters must be configured in each satellite terminal (its own communication address, the identifier of each logical bus to which it is connected, and the number of the beam in which it is located), secondly, adding a satellite terminal to the installation requires only the configuration of the new satellite terminal (the respective configurations of the other satellite terminals remain unchanged), and, thirdly, removing a satellite terminal from the installation does not require reconfiguration of the other satellite terminals.

The invention is not limited to the embodiments of an installation, a satellite terminal and a processing device described hereinabove by way of example only, but encompasses any variants thereof that the person skilled in the art might envisage within the scope of the following claims.

Thus there is described in the foregoing an application to the Ethernet level 2 sending protocol. However, the invention may be used with other level 2 sending protocols, and in particular the 802.4, 802.5 and 802.11 protocols.

1. Device (D) for processing data frames for satellite terminals (STi) of a satellite communication network, having a communication identifier and connected to a communication satellite (SAT) of said network by a satellite connection defining at least one logical bus (B), designated by an identifier, at least two of said satellite terminals (ST1, ST2) being connected to said logical bus (B), characterized in that it comprises processing means (MT) adapted, on receiving packets of a data frame from a first communication equipment (UE1j), connected to a first satellite terminal (ST1) coupled to said device (D), and addressed to a second communication equipment (UE2j), connected to a second satellite terminal (ST2), to encapsulate each packet received in a level 2 sending protocol header comprising the identifier of the bus to which said second satellite terminal (ST2) is connected and the communication identifier of the first satellite terminal (ST1), before it is sent to said satellite (SAT), via said connection.

2. Device according to claim 1, characterized in that a satellite terminal (ST) connected to said logical bus (B) constitutes a level 2 logical bridge.

3. Device according to either claim 1, characterized in that it comprises a memory (M1) in which is stored at least one bus identifier and the communication identifiers of the communication equipment connected to the satellite terminal (ST1) connected to said device (D), and in that said processing means (MT) are adapted to compare the bus identifier contained in the header of each encapsulated packet circulating in the logical bus (B) to said bus identifier stored in the memory (M1), and then, if said bus identifiers are identical, to perform a filtering operation (F2) on the communication address of the second equipment (UE2j).

4. Device according to claim 1, characterized in that it comprises a memory (M2) in which is stored a table of correspondences between communication equipment communication identifiers and logical bus identifiers.

5. Device according to claim 1, characterized in that it is connected to a satellite terminal (ST1) connected to a communication equipment (UE1) providing access to a private network (N1) designated by an access port number, and in that said logical bus (B) is dedicated to said private network (N1).

6. Device according to claim 4, characterized in that said table establishes a correspondence between communication equipment communication identifiers, access port identifiers, and logical bus identifiers, and further characterized in that it is connected to a satellite terminal (ST1) connected to a communication equipment (UE1) providing access to a private network (N1) designated by an access port number, and in that said logical bus (B) is dedicated to said private network (N1).

7. Device according to claim 4, characterized in that, said satellite (SAT) being of the multibeam type to cover a multiplicity of regions (ZC), said private network (N1) being divided in at least two portions (N11,N12) installed in regions (ZC1, ZC2) covered by different beams of said satellite (SAT), and said satellite connection defining an intra-beam logical bus dedicated to each network portion and an inter-beam logical bus dedicated to said private network (N1), said processing means (MT) are adapted to integrate into the level 2 sending protocol header of the packets to be sent the identifier of the intra-beam logical bus or of the inter-beam logical bus to which the second satellite terminal (ST2) is connected and the communication identifier of said first satellite terminal (ST1) that is the destination of said encapsulated packets, so that said satellite (SAT) can perform its level 2 switching function on the basis of the intra-beam or inter-beam bus identifier contained in the header of the encapsulated packets and the beam on which said encapsulated packets reach it.

8. Device according to claim 7, characterized in that said processing means (MT) are adapted to compare the intra-beam or inter-beam bus identifier contained in the header of each encapsulated packet circulating on one or the other of said logical buses to said bus identifiers stored in the memory (M1), and then, if said bus identifiers are identical, to perform a filtering operation (F2) on the communication address of the second equipment (UE2j).

9. Device according to claim 4, characterized in that said table establishes a correspondence between communication equipment communication identifiers, access port identifiers, logical bus identifiers, and beam identifiers, and in that, said satellite (SAT) being of the multibeam type, to cover a multiplicity of regions (ZC), and of the packet switching type, said private network (N1) being divided into at least two portions (N11, N12) installed in regions covered by different beams of said satellite (SAT), designated by beam identifiers, and said satellite connection defining an inter-beam logical bus dedicated to said private network (N1), said processing means (MT) are adapted i) to integrate into the level 2 sending protocol header of the packets to be sent the identifier of the inter-beam logical bus to which the second satellite terminal (ST2) which is the destination of said packets is connected, the communication identifier of said first satellite terminal (ST1), and the identifier of the beam covering the region (ZC2) in which said second satellite terminal (ST2) is installed, so that said satellite (SAT) can perform its level 2 packet switching function on the basis of said identifier of the beam contained in the header of the encapsulated packets.

10. Device according to claim 4, characterized in that said table establishes a correspondence between communication equipment communication identifiers, access port identifiers, logical bus identifiers, and beam identifiers, and in that, said satellite (SAT) being of the multibeam type, to cover a multiplicity of regions (ZC), and of the circuit switching type, said private network (N1) being divided into at least two portions (N11, N12) installed in regions (ZC1, ZC2) covered by different beams of said satellite (SAT), designated by beam identifiers, and said satellite connection defining an inter-beam logical bus dedicated to said private network, said processing means (MT) are adapted i) to integrate into the level 2 sending protocol header of the packets to be sent the identifier of the inter-beam logical bus to which is connected the second satellite terminal (ST2) that is the destination of said packets and the communication identifier of said first satellite terminal (ST1), and ii) to instruct the sending of said encapsulated packets in a time slot dedicated to said beam covering the region (ZC2) in which said second satellite terminal (ST2) is installed, so that said satellite (ST2) can perform its level 2 circuit switching function on the basis of the sending time slot of the encapsulated packets.

11. Device according to claim 9, characterized in that said processing means (MT) are adapted to compare the inter-beam bus identifier contained in the header of each encapsulated packet circulating on said inter-beam logical bus to said bus identifiers stored in the memory (M1), and then, if said bus identifiers are identical, to perform a filtering operation (F2) on the communication address of the second equipment (UJE2j).

12. Device according to claim 4, characterized in that said table establishes a correspondence between communication equipment communication identifiers, access port identifiers, logical bus identifiers, and beam identifiers, and in that, said satellite (SAT) being of the multibeam type, to cover a multiplicity of regions (ZC), and of the packet switching type, said private network (N1) being subdivided into at least two portions (N11, N12) installed in regions covered by one of the beams of said satellite (SAT), designated by beam identifiers, and said satellite connection defining an intra-beam logical bus dedicated to said private network (N1), said processing means (MT) are adapted i) to integrate into the level 2 sending protocol header of the packets to be sent the identifier of the intra-beam logical bus, the communication identifier of said first satellite terminal (ST1), and the identifier of the beam covering the region (ZC) in which is installed said second satellite terminal (ST2) which is the destination of said packets, so that said satellite (SAT) can perform its level 2 packet switching function on the basis of said identifier of the beam contained in the header of the encapsulated packets.

13. Device according to claim 4, characterized in that said table establishes a correspondence between communication equipment communication identifiers, access port identifiers, logical bus identifiers, and beam identifiers, and in that, said satellite (SAT) being of the multibeam type, to cover a multiplicity of regions (ZC), and of the circuit switching type, said private network (N1) being subdivided into at least two portions (N11, N12) installed in a region (ZC) covered by one of said beams of said satellite (SAT), designated by beam identifiers, and said satellite link defining an intra-beam logical bus dedicated to said private network, said processing means (MT) are adapted i) to integrate into the level 2 sending protocol header of the packets to be sent the identifier of the intra-beam logical bus to which the satellite terminal (ST1) is connected and the communication identifier of said first satellite terminal (ST1), and ii) to instruct the sending of said encapsulated packets in a time slot dedicated to said beam covering the region (ZC) in which is installed said second satellite terminal (ST2) that is the destination of said packets, so that said satellite (SA2) can perform its level 2 circuit switching function on the basis of the sending time slot of the encapsulated packets.

14. Device according to claim 13, characterized in that said processing means (MT) are adapted to compare the intra-beam bus identifier contained in the header of each encapsulated packet circulating in said intra-beam logical bus to said bus identifiers stored in the memory (M1), and then, if said bus identifiers are identical, to perform a filtering operation (F2) on the communication address of the second equipment (UE2j).

15. Device according to claim 2, characterized in that said processing means (MT) are adapted to determine by a learning process communication addresses of first and second equipments (UEij) and/or corresponding port numbers and/or corresponding logical bus identifiers and/or corresponding beam identifiers, to feed said correspondence table.

16. The bus according to claim 2, characterized in that said processing means (MT) are adapted to transmit request-frames to a remote satellite terminal (ST2) to determine information representative of a second equipment (UE2j) communication address and/or a corresponding port number and/or a corresponding logical bus identifier and/or a corresponding beam identifier, so as to be able to construct the header of the packets to be sent to said second equipment (UE2j), and then to feed said correspondence table with said information obtained.

17. Device according to claim 16, characterized in that said processing means (MT) are adapted, on receiving said request-frames, to transmit response-frames comprising said required information.

18. Device according to claim 16, characterized in that each request-frame and each response-frame is of the ARP type.

19. Device according to claim 1, characterized in that said level 2 sending protocol is chosen from the Ethernet protocol and the token ring protocol.

20. Primary satellite terminal (STi), characterized in that it comprises a device (Di) according to claim 1.

21. Communication installation provided with at least one communication satellite (SAT), characterized in that it comprises a multiplicity of primary satellite terminals (STi) according to claim 20.

22. Installation according to claim 21, characterized in that each of at least two of said primary satellite terminals (ST1, ST2) is connected to a communication equipment (UE11, UE12) providing access to a private network (N1) and are connected to a first logical bus dedicated to said private network (N1).

23. Installation according to claim 22, characterized in that at least two of said primary satellite terminals (ST3, ST4) are each connected to a communication equipment (UE21, UE22) providing access to another private network (N2) and are connected to another logical bus dedicated to said second private network (N2).

24. Installation according to claim 22, characterized in that at least one of said two private networks (N1, N2) is a virtual network.

25. Installation according to claim 22, characterized in that at least one of the primary satellite terminals is connected to a communication equipment (GW) providing access to a public data network (IP) and at least one of said primary satellite terminals is connected to a communication equipment (UEij) providing access to one of said private networks (N1, N2), said satellite terminals being connected to a logical bus dedicated to said public data network (IP) and providing access to said private network (N1, N2).

26. Installation according to claim 21, characterized in that said satellite (SAT) is of the multibeam type to cover a multiplicity of regions.

27. Installation according to claim 26, characterized in that said private network (N1, N2) is divided into at least two portions (N11, N12; N21, N22) installed in regions covered by different beams of said satellite (SAT), in that said satellite connection defines an intra-beam logical bus dedicated to each network portion and an inter-beam logical bus dedicated to said private network (N1, N2), in that said satellite (SAT) is adapted to perform its level 2 switching on the basis of said intra-beam or inter-beam bus identifier contained in the encapsulated packets to be sent, and in that said primary satellite terminals (STi) coupled to said network portions are adapted to filter the intra-beam bus identifier of their network portion and the inter-beam bus identifier.

28. Installation according to claim 26, characterized in that said private network (N1, N2) is subdivided into at least two portions (N11, N12; N21, N22) installed in regions covered by different beams of said satellite (SAT), each region being associated with a beam identifier, and in that said satellite connection defines an inter-beam logical bus dedicated to said network portions, in that said satellite (SAT) is adapted to perform level 2 packet switching on the basis of the beam identifier and the inter-beam bus identifier contained in the encapsulated packets to be sent, and in that said primary satellite terminals (STi) connected to said network portions are adapted to filter the inter-beam bus identifier.

29. Installation according to claim 26, characterized in that said private network (N1, N2) is subdivided into at least two portions (N11, N12; N21, N22) installed in regions covered by different beams of said satellite, each region being associated with a beam identifier, in that said satellite connection defines an inter-beam logical bus dedicated to said network portions, in that said satellite (SAT) is adapted to perform level 2 circuit switching on the basis of the sending time slot of said encapsulated packets and the inter-beam bus identifier contained in said encapsulated packets to be sent, and in that said primary satellite terminals (STi) connected to said network portions are adapted to filter the inter-beam bus identifier.
